(19) United States
(12) Patent Application Publication
(10) Pub. No.: US 2024/0396964 A1
(43) Pub. Date: Nov. 28, 2024

(54) WORKLOAD DISTRIBUTION TO FAILOVER SITES BASED ON LOCAL SITE PROPERTIES

(71) Applicant: INTERNATIONAL BUSINESS MACHINES CORPORATION, Armonk, NY (US)

(72) Inventors: Miles MULHOLLAND, Eastleigh (GB); Dominic TOMKINS, Alton (GB); Eric John BARTLETT, Chard (GB)

(73) Assignee: INTERNATIONAL BUSINESS MACHINES CORPORATION, Armonk, NY (US)

(21) Appl. No.: 18/323,414

(22) Filed: May 25, 2023

(51) Int. Cl. H04L 67/1021; H04L 41/0663

(52) U.S. Cl. CPC H04L 67/1021; H04L 41/0663

(57) ABSTRACT

Provisioning workloads in a distributed computing environment includes receiving a workload by one or more processors maintained at a primary site located at a first geographical location, which is associated with first geographical characteristics. The workload is associated, based on the first geographical characteristics, with the primary site and the first geographical location using metadata of the workload. A secondary site for the workload, located at a second geographical location having second geographical characteristics, is identified based on the second geographical characteristics satisfying predefined constraints of the workload. The secondary site is established as a backup site to provision the workload to responsive to a failover event occurring.

### BACKGROUND

Embodiments of the invention relate to the distribution of workloads in distributed computing environments, and more particularly, to the distribution of said workloads to backup datacenter sites based on physical and geographical site properties.

### SUMMARY

According to an embodiment, a computer-implemented method for provisioning workloads in a distributed computing environment is disclosed. The computer implemented-method includes receiving a workload by one or more processors maintained at a primary site located at a first geographical location having first geographical characteristics. The one or more processors further associate, based on the first geographical characteristics, the workload with the primary site and the first geographical location using metadata of the workload. The one or more processors further identify a secondary site located at a second geographical location having second geographical characteristics, based on the second geographical characteristics satisfying predefined constraints of the workload. The one or more processors further establish the secondary site as a backup site to provision the workload to responsive to a failover event occurring.

An embodiment includes a computer usable program product. The computer usable program product includes a computer-readable storage device, and program instructions stored on the storage device executable to perform similar functionality.

An embodiment includes a computer system. The computer system includes a processor, a computer-readable memory, and a computer-readable storage device, and program instructions stored on the storage device for execution by the processor via the memory to perform similar functionality.

### BRIEF DESCRIPTION OF THE DRAWINGS

FIG. 1 is a block diagram depicting a computing environment in which operations of the description may be performed.

FIG. 2 is a block diagram depicting a distributed computing and storage environment in which operations of the description may be performed.

FIG. 3 is a flowchart illustrating operations to provision workloads in a distributed computing environment.

FIG. 4 is a flowchart further illustrating operations to provision workloads in a distributed computing environment.

FIG. 5 is a flowchart illustrating operations to score workload sites according to geographical characteristics.

### DETAILED DESCRIPTION OF THE DRAWINGS

In the era of the ever increasing reliance on distributed computing, business impact of loss of information technology (IT) infrastructure can be vast and expansive. Enterprise-class clients, such as banks, financial institutions, hospitals, governments, utility companies, etc. can suffer business losses from even the shortest outages and service interrupts. The cost of downtime could dissolve businesses, or cause irreparable brand damage, loss of customer data and loss of reputation. In order to deliver the level of resiliency needed by various enterprise applications, certain disaster recovery mechanisms need to be put in place to mitigate the impact of disaster scenarios on the infrastructure holding such sensitive data.

Cloud and digital services datacenters that provide critical services typically have business continuation, disaster recovery or disaster avoidance plans in place, in order to support continuous operation in a case of a disaster or major disruptive event. A disaster, for example, may be defined any unforeseen event, which directly or indirectly impacts systems availability of the datacenter beyond acceptable service levels to clients that would result in the decision to continue (or transfer) operations at an alternate processing site.

Among other techniques, disaster recovery mechanisms may be implemented through data snapshots of workload operations (executed by datacenter computing resources) being taken (and stored) at certain intervals at a primary site (i.e., a primary datacenter executing the workloads of client(s)), and then periodically copied to a secondary site (i.e., a backup datacenter to the primary datacenter) remotely located to the primary site. During a disaster in which the primary datacenter is no longer accessible and/or no longer able to adequately execute the workloads of the client(s), the service is restored to client(s) by booting servers at the secondary site (or otherwise provisioning running servers) from the snapshot images and workload storage, and resuming executing those workloads by the server's resources at the secondary site. In this way, the disaster recovery mechanisms perform a “failover” from the primary site to the secondary site during the disaster, and the secondary site thus becomes (at least for a time) the primary site assigned to execute and continue the workloads of the client(s).

Selection of these secondary sites for which to provision workloads to during a failover event (i.e., the disaster affecting the primary site) is generally based on considerations such as (yet without limitation) a distance of the secondary site to the primary site (and/or whether the primary and secondary sites are geographically located in a similar/differing region), connectivity between the primary and secondary sites, storage and/or computational capacity at the secondary site, types of resources (or resource vendors) of equipment at the secondary site, service level agreement (SLA) requirements of workloads that may at some time execute at the secondary site, governmental and/or regulatory requirements constraining these workloads, etc. For example, when initially establishing cloud hosting of workloads, means to provision capacity in a fashion which is tied to a general geographic area (e.g., ‘North America-East coast’, or ‘Europe-London’) may be provided (with some equipment vendors allowing for city-specific provisioning). However, these mechanisms allow for only a coarse-grained allocation preference for executing workloads at a primary (and, if applicable, a backup) site.

What these selection criterion fail to consider, however, is an overall risk profile of geographical and physical properties of a geography associated with the primary and secondary site(s) of which workloads are provisioned to. For example, even when technical properties of both the primary and secondary sites “check all the boxes” of good candidate sites to provision a workload to (e.g., the primary and secondary site are located at a relatively fair distance from one another in a similar region so as not to incur excessive latency, the primary and secondary site maintain good connectivity with one another using latest networking standards, and each site satisfies the computational, data storage, resource type, regulatory, and/or SLA requirements of the workload), the secondary site may still be a less than desirable choice when analyzing further site considerations.

For instance, consider that a workload of a client is provisioned to a primary site that is geographically located (i.e., physically located) in a known tectonic risk area or region subject to earthquakes (or at relatively much higher risk than average to experience an earthquake). Consider that a secondary site is selected to mirror the data of and/or provision the workload to during a failover event, and this secondary site (while satisfying all other workload backup considerations) is similarly located in the area or region with known tectonic risk. Although the primary and secondary sites seem to be a good pair for provisioning the workload when analyzing conventional considerations, during event of an earthquake, it is likely that both the primary and secondary sites will be affected due to their similar geographical risk. Thus, any backup protection to the workload in such a scenario may be negated, which of course subverts the entire practice of arranging disaster recovery for the workload in the first instance.

In this situation, given that the primary site is located in a known tectonic risk area or region, it may be prudent to instead select a secondary site for the workload which is not located in such a region with tectonic risk-provided that the secondary site selected in a lower or non-risk region similarly meets the requirements of the workload (and/or that any properties of the selected secondary site in the lower-risk region which are inferior to the secondary site located in the higher-risk region are worth the trade-off).

To practically implement such operations, embodiments of the invention described herein thus provide technical solutions for optimally distributing workloads among primary and secondary sites according to geographical and physical properties of said sites. In an embodiment, these solutions include receiving a workload by one or more processors maintained at a primary site located at a first geographical location, which is associated with first geographical characteristics. The workload is associated, based on the first geographical characteristics, with the primary site and the first geographical location using metadata of the workload. A secondary site for the workload, located at a second geographical location having second geographical characteristics, is identified based on the second geographical characteristics satisfying predefined constraints of the workload. The secondary site is established as a backup site to provision the workload to responsive to a failover event occurring.

In an embodiment, the associating using the metadata includes geotagging at least one of a container executing the workload and a storage device associated with the workload.

In an embodiment, each of the first and second geographical characteristics are selected from the list comprising: weather factors, land topology factors, tectonic factors, electricity grid reliability factors, governance factors, and regulatory factors.

In an embodiment, the one or more processors construct a map leveraging layers selected from at least one of the first geographical characteristics and the second geographical characteristics.

In an embodiment, the identifying of the secondary site further includes: identifying, by the one or more processors, a plurality of candidate secondary sites on the map according to initial constraints; ordering, by the one or more processors, the plurality of candidate secondary sites according to a comparison of the first geographical characteristics, the second geographical characteristics, and the predefined constraints; and selecting, by the one or more processors, the secondary site as one or more of the plurality of candidate secondary sites based on the comparison.

In an embodiment, the predefined constraints establish those of the second geographical characteristics of the second geographical location that compensate for predefined risk areas of the first geographical characteristics of the first geographical location.

In an embodiment, the one or more processors monitor the first geographical characteristics, the second geographical characteristics, and the predefined constraints.

In an embodiment, the one or more processors re-identify the secondary site based on one or more changes detected during the monitoring.

It should be noted that in some embodiments, at least some of the functionality described herein (e.g., the determination, selection, and provisioning of workloads to secondary sites) may be performed utilizing a cognitive analysis. As such, in those embodiments, the methods and/or systems described herein may perform determinative operations for implementing the operations of the invention using such a cognitive analysis, “cognitive system,” “machine learning,” “cognitive modeling,” “predictive analytics,” and/or “data analytics,” as is commonly understood by one skilled in the art.

Generally, these processes may include, for example, executing machine learning logic or program code to receive and/or retrieve multiple sets of inputs, and the associated outputs, of one or more systems and processing the data (e.g., using a computing system and/or processor) to generate or extract models, rules, etc. that correspond to, govern, and/or estimate the operation of the system(s), or with respect to the embodiments described herein, the identification, determination, selection and provisioning of secondary sites for said workloads, as described herein. Utilizing models generated by the system, the performance (or operation) of the system (e.g., utilizing/based on new inputs) may be predicted and/or the performance of the system may be optimized by investigating how changes in the input(s) effect the output(s). Feedback received from (or provided by) users and/or administrators may also be utilized, which may allow for the performance of the system to further improve with continued use.

In certain embodiments, the cognitive analyses described herein may apply one or more heuristics and machine learning based models using a wide variety of combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

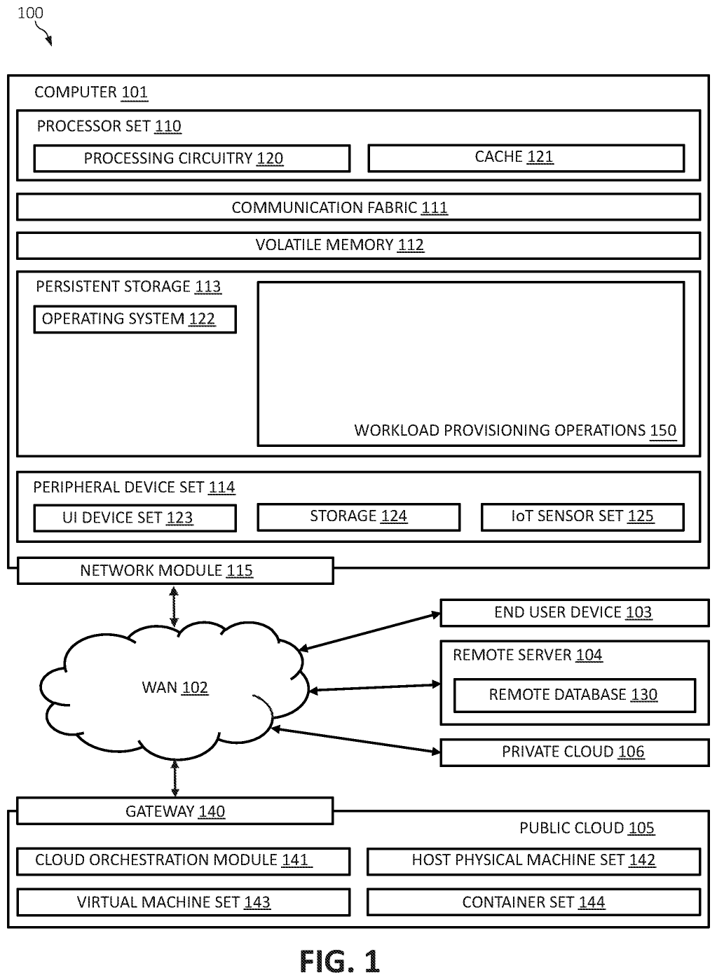

Turning now to FIG. 1, computing environment 100 contains an example of an environment for the execution of at least some of the computer code involved in performing the inventive methods, such as workload provisioning operations module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

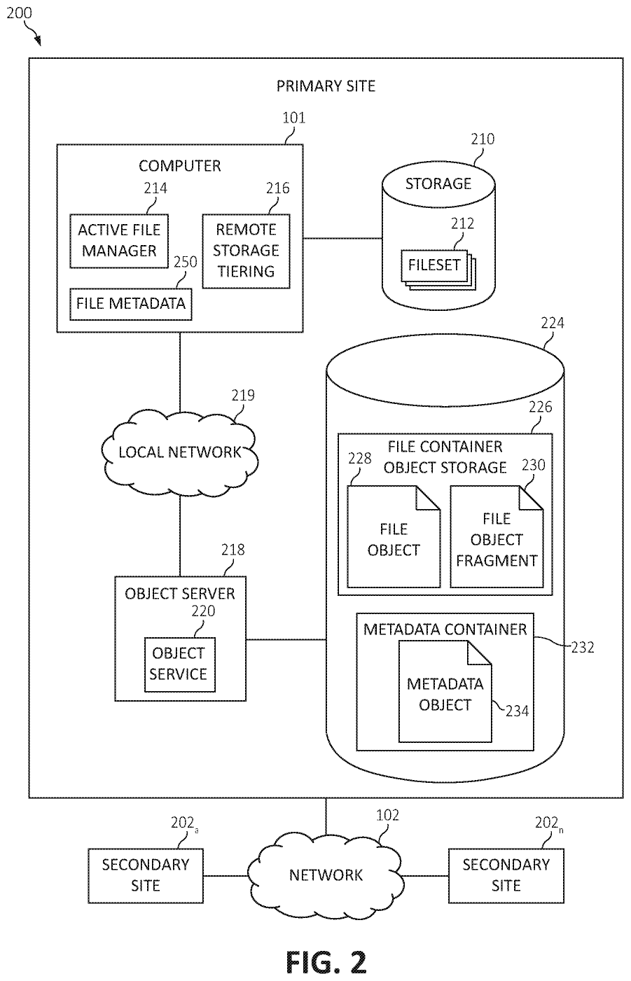

FIG. 2 illustrates an embodiment of a distributed computing and storage environment (e.g., a cloud environment) in which the computer 101 may be implemented. The distributed computing and storage environment may include a primary site 200 and secondary sites 202a . . . 202n that communicate over the network 102 (which again, may comprise a WAN). The primary site 200 and secondary sites 202a . . . 202n may be at disparate geographical locations, so that any one of the sites can be used as an alternate if a disaster occurs at one site. Further, clients/hosts (not shown) may direct read and writes to the primary site 200 and only reads to the secondary sites 202a . . . 202n. In the event of a failure at the primary site 200, a failover may occur to one of the secondary sites 202a . . . 202n which then operates as the failover primary site, as commonly understood in the art. The primary site 200 may include the computer 101 (which may operate as a storage/compute server for the primary site 200) and a storage 210 including filesets 212 that comprise a file system or partitions of a file system including files. The computer 101 may further include an active file manager 214 to manage read and write requests from connected clients or local processes to the filesets 212 and replicate files to filesets in the file systems at the secondary sites 202a . . . 202n. The active file manager 214 may maintain file metadata 250 providing metadata for each file in the filesets 212. The computer 101 further includes a remote storage tiering 216 program to migrate files as objects to an object storage according to an archival policy, such as an Information Lifecycle Management (ILM) policy, to move files that satisfy certain file size and other criteria.

The secondary sites 202a . . . 202n may further include one or more instances of the computer 101, and components 214, 216, 250, and storage 210 as described with respect to the primary site 200 to maintain a copy of the filesets 212 at the primary site 200.

The primary site 200 may communicate with an object server 218 over a local area network 219. The object server 218 may include an object service 220 to handle, for example, GET (access) and PUT (transfer) requests toward containers in an object storage 224. The object storage 224 may include a file container 226 to store a file object 228 having the entire file or file object fragments 230, comprising a fragment of the entire file when the file is stored as fragments distributed across the sites 200, 202a . . . 202n, and a metadata container 232 to store metadata objects 234 having the file metadata for the files stored as objects. In certain distributed object embodiments, the containers 226 and 232 may span multiple of the sites in the network 102. The containers may be defined by a policy to store a full copy of data at each site or may be defined to fragment the data, for example, using erasure coding techniques, across all sites with only part of the data at each site.

In one embodiment, the file container 226 may be defined with a file policy to encode the data for a file into fragments and then stream to the secondary sites 202a . . . 202n to store as distributed fragments. In this way, each file container 226 at the sites 200, 202a . . . 202n stores only a fragment 230 of the file data. The metadata container 232 may be defined with a policy to make a full copy of the file metadata objects 234 to the secondary sites 202a . . . 202n. In one embodiment, the file container 226 spanning the sites may not store a full copy of the file object migrated to the file container 226, but just the one or more file object fragments 230 distributed among the sites. Alternatively, the file container 226 spanning the sites may store the full copy of the file object 228.

Each of the secondary sites 202a . . . 202n may further include their own instance of a local area network 219, object server 218, object service 220, object storage 224, an implementation of the file container 226 and metadata container 232 distributed across sites, where file object fragments 230 for a file may be stored across the secondary sites 202a . . . 202n. If a request is received at one of the sites 200, 202a . . . 202n for a file in a fileset 212, if the file metadata 250 indicates the file is not stored in the local storage 210 but instead as an object in a file container 226, then the remote storage tiering 216 in the secondary site 202a . . . 202n recalls the file object 228 from the file container 226. The file metadata 250 may comprise inodes or other types of file metadata. In an embodiment, the file metadata 250 may be tagged, appended, and/or otherwise include geo-location information associated with the primary site 200 and/or the secondary sites 202a . . . 202n.

In one embodiment, the object service 220 may use erasure coding to encode a file into fragments to stream to the secondary sites 202a . . . 202n based on object storage technology known in the art, such as ring locations. The file object fragments 230 may comprise data and parity fragments to allow recovery of the data fragments. In some embodiments, other techniques may be used to distribute object data at secondary sites throughout a network. The object data may be distributed across the sites such that data access and integrity is maintained even in the event of a complete loss of one or more of the sites 200, 202a . . . 202n.

The file objects 228 may comprise an unstructured data format suitable for storing large amounts of data. Further, the file objects 228 may be accessed over the network 106 using Universal Resource Locators (URLs) Hypertext Transport Protocol (HTTP) commands and Application Programming Interfaces (APIs). The file objects 228 may be stored in containers for an account. For instance, the object service 220 may implement the OpenStack Object Storage (swift) system with erasure coding support encoding object data as fragments distributed across storage nodes over the network 102. The remote storage tiering 216 includes an object interface to GET and PUT file and file metadata 250 to containers 226 and 232.

The storages 210 and 224 may comprise different types or classes of storage devices, such as magnetic hard disk drives, solid state storage device (SSD) comprised of solid state electronics, EEPROM (Electrically Erasable Programmable Read-Only Memory), flash memory, flash disk, Random Access Memory (RAM) drive, storage-class memory (SCM), etc., Phase Change Memory (PCM), resistive random access memory (RRAM), spin transfer torque memory (STT-RAM), conductive bridging RAM (CBRAM), magnetic hard disk drive, optical disk, tape, etc. Data in the storages 210 and 224 may further be configured from an array of devices, such as Just a Bunch of Disks (JBOD), Direct Access Storage Device (DASD), Redundant Array of Independent Disks (RAID) array, virtualization device, etc. Further, the storages 210 and 224 may comprise heterogeneous storage devices from different vendors and different types of storage devices, such as a first type of storage devices (e.g., hard disk drives), that have a slower data transfer rate than a second type of storage devices (e.g., SSDs).

Similar to network 102, network 219 may comprise one or more networks including Local Area Networks (LAN), Storage Area Networks (SAN), Wide Area Network (WAN), peer-to-peer network, wireless network, the Internet, etc.

As used herein, the term “client” (and/or “host”) means a processing device or system, such as a workstation, desktop computer, mobile computer, tablet computer or the like that resides client-side in a client/server(s) relationship with the primary site 200 and/or secondary sites 202a . . . n. As used herein, the term “workload” means a unit of work to be performed by one or more computing resources. Such computing resources may be provided by a cloud, for example, depicted as primary site 200 and secondary sites 202a . . . n. A workload also may be referred to as a “cloud asset.” Accordingly. the resources of the computer 101 at the primary site 200, the storage 210, the object server 218. and/or the object storage 224 (and similarly the instances each thereof at secondary sites 200a . . . n) may collectively be utilized to receive, execute, store, and/or transmit data associated with a workload requested by the client commensurate with the aforementioned description.

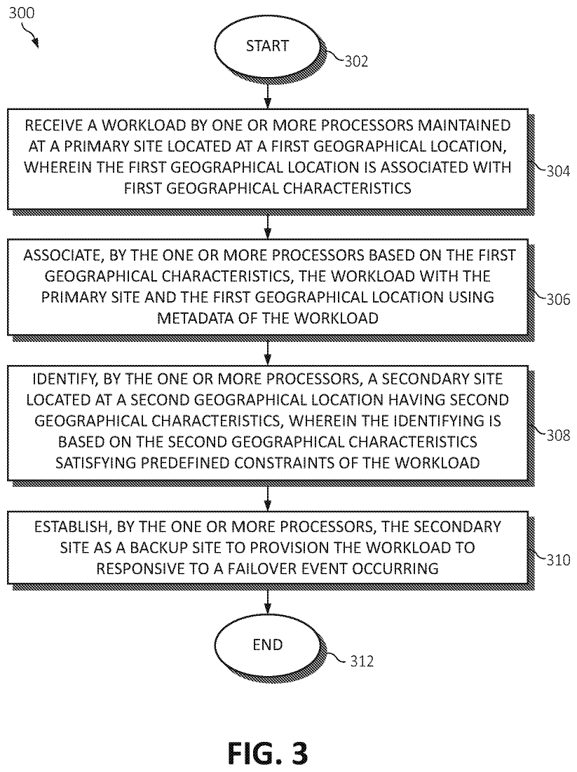

Referring now to FIG. 3, a computer-implemented method 300 for provisioning workloads in a distributed computing environment is illustrated. It should be understood that the operations of the computer-implemented method 300 may be performed by the processor set 110 of the computer 101 depicted in the computing environment 100 of FIG. 1 by executing computer code of the workload provisioning operations module 150, commensurate with the description of such in FIGS. 1 and 2.

The computer-implemented method 300 starts (step 302), with a workload being received by one or more processors maintained at a primary site located at a first geographical location, where the first geographical location is associated with first geographical characteristics (step 304). The one or more processors further associate, based on the first geographical characteristics, the workload with the primary site and the first geographical location using metadata of the workload (step 306). The one or more processors further identify a secondary site, located at a second geographical location having second geographical characteristics, based on the second geographical characteristics satisfying predefined constraints of the workload (step 308). The one or more processors further establish the secondary site as a backup site to provision the workload to responsive to a failover event occurring (step 310). The computer-implemented method 300 ends (step 312).

As the computer-implemented method 300 demonstrates, a given workload (i.e., a new or pre-existing workload at primary site 200 received from and/or instructed by a particular client) may be associated with the primary site 200, which is physically located at a particular geographical location (e.g., North America-San Jose). This association to the workload may be formed, for example, by geotagging a container running the workload (i.e., adding geographical identification metadata in the object metadata 234 of the metadata container 232) and/or the storage associated with this workload (i.e., adding the geographical identification information metadata in the file metadata 250 associated with a fileset 212 of the workload).

In an embodiment and as part of forming this association, a map may be constructed by computer 101 which leverages layers depicting information on certain physical and geographical information which is associated with the primary site 200 and/or the secondary sites 202a . . . n. For example, a basemap may be constructed according to the physical and geographical properties of the respective datacenter site which serves as the basis for mapping the layers in their geospatial context.

These geographical layers of the map may depict, for example yet without limitation, weather factors (e.g., average, historical, forecasted, and/or date-specific temperatures, humidity, precipitation, atmospheric pressure, wind speed, wind direction, cloud cover, ultraviolet (UV) index, etc.), land topology factors (e.g., elevation, slope angle, slope aspect, general curvature, plan curvature, profile curvature, climactic factors, physiographic factors, edaphic factors, biotic factors, etc.), tectonic factors (e.g., heat/gravity factors, tectonic plate boundaries, erosion and tectonic processes, etc.), electricity grid reliability factors (average, historical, and/or forecasted electricity outages, electrical utility information, reputation information, electrical utility equipment information, backup electrical capacity information, etc.), governance factors (e.g., laws, statutes, and/or governmental policies dictating the transmission and storage of certain data, general data protection regulation (GDPR) states, import-export requirements, political stability, etc.), and regulatory factors (e.g., company, organizational, and/or client-imposed rules, policies, and/or procedures dictating the transmission and storage of certain data, etc.).

In an embodiment, multiple data sources (not depicted) utilized to generate information associated with the geographical layers on the map may be provided as a corpus or group of data sources defined and/or identified. The data sources may include, but are not limited to, data collected from Internet sources, data sources relating to one or more documents, historical records, government records, newspaper articles and images, mapping and geographical records and data, structural data (e.g., buildings, landmarks, etc.), books, scientific papers, journals, articles, drafts, materials related to emails, audio data, images or photographs, video data, and/or other various documents or data sources capable of being analyzed, published, displayed, interpreted, and/or transcribed.

With the mapping information having been generated, a geographical profile of the workload may be determined for the existing workload executing at the primary site 200 through an analysis of the geographical layers, physical location information, and/or tangible and/or non-tangible data points associated with the primary site 200 (and/or the secondary sites 202a . . . n). By way of example only, the geotag applied to the object metadata 234 of the metadata container 232 and/or the file metadata 250 associated with the fileset 212 of the existing workload at the primary site 200 may include similar information and/or be of a similar structure to the following:

WORKLOAD 0x122:
LOCATION: grid-square-01264
LOCATION_PROPERTY: FLOOD_RISK_HIGHER (100 YEARS)
LOCATION_PROPERTY: FLOOD_PLAIN_RHINE
LOCATION_PROPERTY: EU_GDPR
LOCATION_PROPERTY: TECTONIC_RISK_LOW
LOCATION_PROPERTY: POWER_GRID_UCTE

Based on these identified properties of workload and the primary site 200 through its geographical profile, provisioning of the backup workload to one or more of the secondary sites 202a . . . n may be enhanced through the consideration of site properties that compliment and/or compensate for identified risk properties associated with the primary site 200. While certain properties may exist that are desirable to maintain as common for the workload at the primary site 200 and the backup workload at the secondary sites 202a . . . n (e.g., regulatory requirements, such as GDPR requirements), other properties may be desirable to maintain as distinct. For example, if one or more of the secondary sites 202a . . . n identified as (candidate) backup site(s) for the workload are located in a high flood risk area and the primary site 200 is not located in a high flood risk area, the failure risk to provision the backup workload at the one or more secondary sites 202a . . . n may be acceptable. However, were the primary site 200 to be located in such a high flood risk area, it would not be desirable to provision the backup workload to one or more of the secondary sites 202a . . . n located in a similar risk environment (i.e., both primary and backup sites being located in high flood risk locations).

In an embodiment, when determining which of the secondary sites 202a . . . n to provision a backup of a workload to in event of failover of the workload from primary site 200, a shortlist of candidate backup sites may be constructed according to the geographical profile of the workload, geographical and physical properties of each of the secondary sites 202a . . . n, predefined constraints of the workload, and/or additional constraints. This list may include, for example, sites within the entire cloud ecosystem of a given organization or, in another example, restricted to datacenters which are within certain predefined parameters (e.g., those of the secondary sites 202a . . . n within an acceptable latency range of the geotag associated with the workload at the primary site 200).

In some implementations, the computer 101 may compare the characteristics of the primary site 200 and each of the secondary sites 202a . . . n (i.e., compare those of the characteristics at each site which compliment and/or compensate for one another) to identify those of the secondary sites 202a . . . n to be included on the list of candidate sites. The computer 101 may then iterate through each of the candidate sites on the list, analyzing each of the secondary sites 202a . . . n to identify the lowest risk site (contextually with respect to characteristics of the primary site 200) subject to additional constraints. These additional constraints may include, for example, resource capacity and/or costs associated with each of the respective sites on the list. In another example, the additional constraints may include those of the respective sites on the list having a lowest latency to the primary site 200 and/or the costs associated with each of the respective sites on the list while being subject to an acceptable risk profile.

For instance, when generating the list of candidate sites of the secondary sites 202a . . . n to provision a backup workload to for a workload to be executed (or currently executing) at primary site 200, if the primary site 200 is associated with geographical characteristics which include a high flood risk, a high tectonic risk, or a high-risk of electrical grid failure, the secondary sites 202a . . . n may be ordered on the list as sites which do not include such risks and/or sites in a determined order (or ranking) of acceptable risk. For example, if the primary site 200 is in an extremely high-risk flood area, a moderate risk tectonic area, and a low-risk of electrical grid failure, the candidate sites on the list may be ranked in ascending (or descending) order of those of the secondary sites 202a . . . n which are geographically located in a low-risk flood area, a low/moderate risk tectonic area, and a low-risk of electrical grid failure area. In another example similar to one discussed previously, if the primary site 200 has relatively no risk characteristics of a certain parameter, the candidate sites may include those within an acceptable risk level, such as a moderate risk tectonic or flood risk (after having considered the additional constraints imposed by the client and/or the administrator, such as latency, capacity, and cost considerations).

In certain embodiments, each of the geographical and physical characteristics of the candidate sites of the secondary sites 202a . . . n may be weighted according to predefined metrics. For example, in one region it may be more acceptable to consider backup sites with relatively higher flood or tectonic risks than in other regions, or vice versa. Accordingly, the weights applied to each of the characteristics used to rank the candidate sites may be organizational, region, and/or client-specific. In certain embodiments, a scoring mechanism (discussed following) may be utilized to score each of the characteristics of each of the candidate sites according to the defined weight of each characteristic. In some implementations, such characteristics may be imposed and/or selected by clients, for example, as part of an SLA of the workload. Further, some implementations may include referencing regulatory policies, rules, and/or laws affecting the provisioning of workloads to particular geographical locations (e.g., GDPR).

In an embodiment, machine learning and/or a cognitive analysis of the primary site 200 and the secondary sites 202a . . . n may be utilized to generate the list of candidate backup sites. For example, in generating the list of candidate sites, a machine learning model may be leveraged to determine the best sites for provisioning the backup to after having taken into consideration the geographical and physical information of each respective site. Machine learning logic may, for instance, receive input of the information from the multiple data sources with respect to the primary site 200 and the secondary sites 202a . . . n, workload constraints (e.g., as set by the client) and additional constraints (e.g., as set by the organization/administrator). The machine learning logic may then generate a machine learning model which identifies and outputs the list of those of the secondary sites 202a . . . n which complement and/or ameliorate risk factors associated with the primary site 200 and/or secondary sites 202a . . . n (while considering the workload and/or additional constraints). Feedback data (e.g., from an administrator) with respect to the model may further be utilized to incrementally improve the candidate predictions over time as the generated model matures.

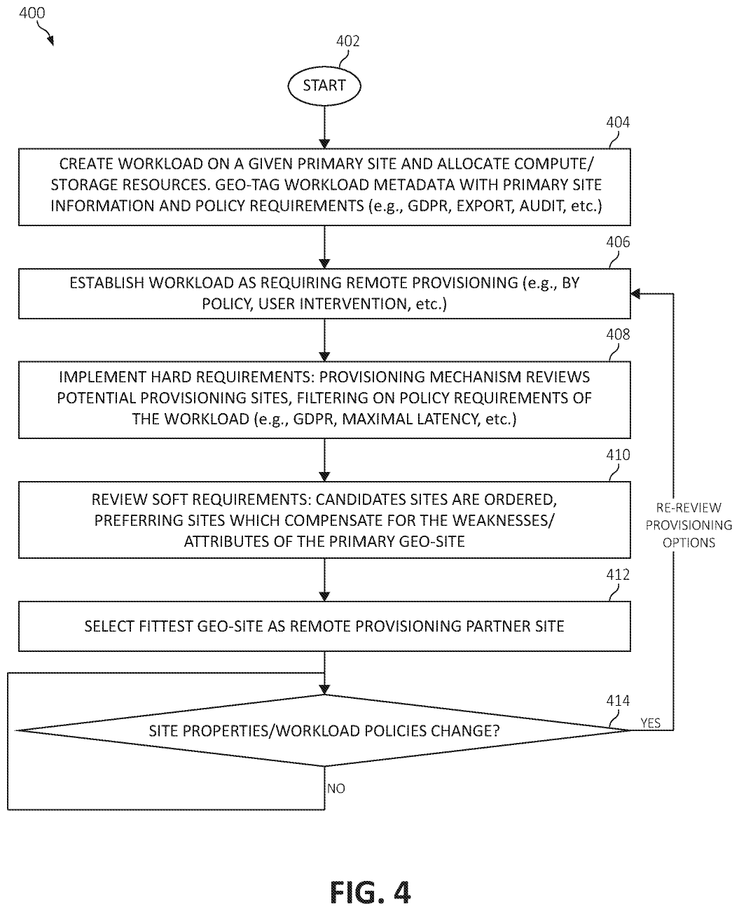

Referring now to FIG. 4, a computer-implemented method 400 for provisioning workloads in a distributed computing environment is illustrated. It should be understood that the operations of the computer-implemented method 400 may be performed by the processor set 110 of the computer 101 depicted in the computing environment 100 of FIG. 1 by executing computer code of the workload provisioning operations module 150, commensurate with the description of such in FIGS. 1-3.

The computer-implemented method 400 starts (step 402) with the creation of a workload at primary site 200, where resources (processor set 110/storage 210, 224) are allocated to the workload. A geographical profile of the workload is created utilizing information from the multiple data sources, and the workload is geo-tagged (geographical metadata information applied to the object metadata 234 of the metadata container 232 and/or the file metadata 250 associated with the fileset 212 of the workload at the primary site 200) with primary site 200 information and/or any applicable policy requirements (e.g., GDPR, export/audit restrictions, etc.) (step 404).

The workload is established as requiring remote provisioning (e.g., by policy, SLA, user intervention, etc.) (step 406). Hard requirements of the workload are implemented (i.e., the workload constraints and/or additional constraints) by a provisioning mechanism of computer 101, which reviews a generated list of potential candidate backup sites of the secondary sites 202a . . . n to provision the workload to, and filters the candidate sites based on the policy requirements/workload constraints (e.g., GDPR, maximal latency, cost, etc.) (step 408).

The provisioning mechanism continues to review soft requirements of the workload by ordering the candidate sites on the list of secondary sites 202a . . . n in a ranked order that prefers sites which compensate and/or ameliorate identified risk characteristics of the primary site 200 (step 410).

The “fittest” or “best” candidate site(s) of the secondary sites 202a . . . n is then selected as the backup site (i.e., a remote provisioning partner site) to the primary site 200 for the workload, and this candidate site(s) is then established as the backup site for the workload to failover the workload to in a disaster event (step 412). As mentioned, the “fittest” candidate site(s) may include those of the secondary sites 202a . . . n on the list of candidate sites which have a highest (or lowest) score when considering the weighted characteristics of the primary site 200, each of the secondary sites 202a . . . n, and the constraints/additional constraints of the workload.

Subsequent to the backup site(s) being selected and the backup workload being established thereto, site properties of the selected backup site(s) and constraints/policies of the workload are continually monitored (step 414). If, at step 414, a change is detected in a characteristic of the primary site 200 and/or the backup site(s) of the secondary sites 202a . . . n (e.g., one of the sites being previously scored as a low-risk flood region is now scored as a high-risk flood region), and/or if workload constraints change (e.g., due to SLA, regulatory, or organizational requirements), the computer-implemented method 400 returns to step 406 to re-review backup provisioning options for the workload consistent with steps 406-412.

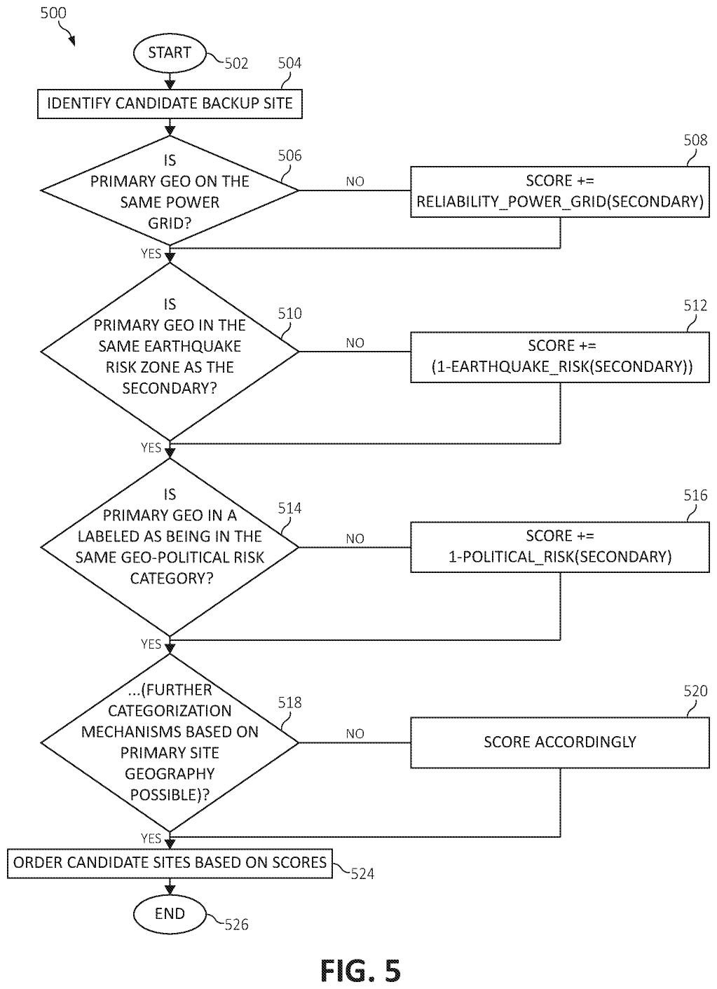

Continuing to FIG. 5, an example implementation of site characteristic scoring operations 500 utilized by the provisioning mechanism (and/or machine learning logic) is illustrated. It should be understood that the site characteristic scoring operations 500 may be performed by the processor set 110 of the computer 101 depicted in the computing environment 100 of FIG. 1 by executing computer code of the workload provisioning operations module 150, commensurate with the description of such in FIGS. 1-4.

The scoring operations 500 start (step 502) by identifying, for a workload executing at primary site 200, one of the secondary sites 202a . . . n as a candidate backup site to include on the list of candidate sites. A comparison of various characteristics of the primary site 200 and each of the secondary sites 202a . . . n may commence in step 506, with a determination as to whether the primary site 200 utilizes the same power grid, electrical connectivity, and/or utility provider as the candidate site (step 506). If the primary and candidate sites do not share the same power grid, the candidate site may be scored accordingly (e.g., assigned a more favorable value) based on a predefined weighted value for grid sharing (step 508), and the operations 500 may continue to a next consideration.

As the next characteristic consideration, a determination may be made as to whether the primary site 200 is geographically located within a same earthquake risk zone (i.e., tectonic area or region) as the candidate site (step 510). If the primary and candidate sites do not both reside in such a risk area, the candidate site may again be scored accordingly (e.g., assigned a more favorable value) based on a predefined weighted value for tectonic risk (step 512), and the operations 500 may continue to a next consideration.

As the next characteristic consideration, a determination may be made as to whether the primary site 200 is geographically located within a same region, country, governance, and/or political risk zone as the candidate site (step 514). If the primary and candidate sites do not both reside in such a risk area, the candidate site may again be scored accordingly (e.g., assigned a more favorable value) based on a predefined weighted value for geo-political risk (step 516), and the operations 500 may continue to a next consideration.

As the final characteristic consideration of operations 500, a determination may be made as to whether the primary site 200 is geographically located within any other identified risk zones or areas as defined by a client, administrator, and/or machine learning logic (step 518). If the primary and candidate sites do not both reside in such a risk area, the candidate site may again be scored accordingly (e.g., assigned a more favorable value) based on a predefined weighted value for the given characteristic (step 520). The operations 500 may then compute a final weighted score, or scores, for the candidate site, and continue to placing the candidate site in its respective order in the ranking of candidate sites of the list of secondary sites 202a . . . n according to this score(s). The operations end (step 526) with an output of a completed, ranked list of the secondary sites 202a . . . n identified as candidate sites for which to provision the backup workload to.

It should be noted that, as used herein, the terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

1. A computer-implemented method for provisioning workloads in a distributed computing environment, the computer-implemented method comprising:
receiving a workload by one or more processors maintained at a primary site located at a first geographical location, wherein the first geographical location is associated with first geographical characteristics;
generating a geographical profile for the workload utilizing information from a plurality of data sources, wherein the profile is geo-tagged with site-specific information associated with the primary site;
associating, by the one or more processors based on the first geographical characteristics, the workload with the primary site and the first geographical location using metadata of the workload;
identifying, by the one or more processors, a secondary site located at a second geographical location having second geographical characteristics while satisfying predefined constraints and matching the site-specific information within the geographical profile; and
establishing, by the one or more processors, the secondary site as a backup site to provision the workload to responsive to a failover event occurring.

2. The computer-implemented method of claim 1, wherein the associating using the metadata includes geotagging at least one of a container executing the workload and a storage device associated with the workload.

3. The computer-implemented method of claim 1, wherein each of the first and second geographical characteristics are selected from the list comprising: weather factors, land topology factors, tectonic factors, electricity grid reliability factors, governance factors, and regulatory factors.

4. The computer-implemented method of claim 1, further comprising constructing, by the one or more processors, a map leveraging layers selected from at least one of the first geographical characteristics and the second geographical characteristics.

5. The computer-implemented method of claim 4, wherein the identifying of the secondary site further includes:
identifying, by the one or more processors, a plurality of candidate secondary sites on the map according to initial constraints,
ordering, by the one or more processors, the plurality of candidate secondary sites according to a comparison of the first geographical characteristics, the second geographical characteristics, and the predefined constraints, and
selecting, by the one or more processors, the secondary site as one or more of the plurality of candidate secondary sites based on the comparison.

6. The computer-implemented method of claim 1, wherein the predefined constraints establish those of the second geographical characteristics of the second geographical location that requisitely compensate for predefined risk areas of the first geographical characteristics of the first geographical location.

7. The computer-implemented method of claim 1, further comprising:
monitoring, by the one or more processors, the first geographical characteristics, the second geographical characteristics, and the predefined constraints, and
re-identifying, by the one or more processors, the secondary site based on one or more changes detected during the monitoring.

8. A system for provisioning workloads in a distributed computing environment, comprising:
one or more processors; and
one or more memory storing instructions executed by the one or more processors, the instructions, when executed, causing the one or more processors to:
receive a workload by the one or more processors maintained at a primary site located at a first geographical location, wherein the first geographical location is associated with first geographical characteristics;
generate a geographical profile for the workload utilizing information from a plurality of data sources, wherein the profile is geo-tagged with site-specific information associated with the primary site;
associate, based on the first geographical characteristics, the workload with the primary site and the first geographical location using metadata of the workload;
identify a secondary site located at a second geographical location having second geographical characteristics while satisfying predefined constraints and matching the site-specific information within the geographical profile; and
establish the secondary site as a backup site to provision the workload to responsive to a failover event occurring.

9. The system of claim 8, wherein the associating using the metadata includes geotagging at least one of a container executing the workload and a storage device associated with the workload.

10. The system of claim 8, wherein each of the first and second geographical characteristics are selected from the list comprising: weather factors, land topology factors, tectonic factors, electricity grid reliability factors, governance factors, and regulatory factors.

11. The system of claim 8, wherein, when executed, the executable instructions further cause the one or more processors to construct, by the one or more processors, a map leveraging layers selected from at least one of the first geographical characteristics and the second geographical characteristics.

12. The system of claim 11, wherein the identifying of the secondary site further includes:
identifying, by the one or more processors, a plurality of candidate secondary sites on the map according to initial constraints,
ordering, by the one or more processors, the plurality of candidate secondary sites according to a comparison of the first geographical characteristics, the second geographical characteristics, and the predefined constraints, and
selecting, by the one or more processors, the secondary site as one or more of the plurality of candidate secondary sites based on the comparison.

13. The system of claim 8, wherein the predefined constraints establish those of the second geographical characteristics of the second geographical location that requisitely compensate for predefined risk areas of the first geographical characteristics of the first geographical location.

14. The system of claim 8, wherein, when executed, the executable instructions further cause the one or more processors to:
monitor, by the one or more processors, the first geographical characteristics, the second geographical characteristics, and the predefined constraints, and
re-identify, by the one or more processors, the secondary site based on one or more changes detected during the monitoring.

15. A computer program product for provisioning workloads in a distributed computing environment, the computer program product comprising:
one or more computer readable storage media, and program instructions collectively stored on the one or more computer readable storage media, the program instructions comprising:
program instructions to receive a workload by one or more processors maintained at a primary site located at a first geographical location, wherein the first geographical location is associated with first geographical characteristics;
program instructions to generate a geographical profile for the workload utilizing information from a plurality of data sources, wherein the profile is geo-tagged with site-specific information associated with the primary site;
program instructions to associate, by the one or more processors based on the first geographical characteristics, the workload with the primary site and the first geographical location using metadata of the workload;
program instructions to identify, by the one or more processors, a secondary site located at a second geographical location having second geographical characteristics while satisfying predefined constraints and matching the site-specific information within the geographical profile; and
program instructions to establish, by the one or more processors, the secondary site as a backup site to provision the workload to responsive to a failover event occurring.

16. The computer program product of claim 15, wherein the associating using the metadata includes geotagging at least one of a container executing the workload and a storage device associated with the workload.

17. The computer program product of claim 15, wherein each of the first and second geographical characteristics are selected from the list comprising: weather factors, land topology factors, tectonic factors, electricity grid reliability factors, governance factors, and regulatory factors.

18. The computer program product of claim 15, wherein the identifying of the secondary site further includes:
constructing, by the one or more processors, a map leveraging layers selected from at least one of the first geographical characteristics and the second geographical characteristics,
identifying, by the one or more processors, a plurality of candidate secondary sites on the map according to initial constraints,
ordering, by the one or more processors, the plurality of candidate secondary sites according to a comparison of the first geographical characteristics, the second geographical characteristics, and the predefined constraints, and
selecting, by the one or more processors, the secondary site as one or more of the plurality of candidate secondary sites based on the comparison.

19. The computer program product of claim 15, wherein the predefined constraints establish those of the second geographical characteristics of the second geographical location that requisitely compensate for predefined risk areas of the first geographical characteristics of the first geographical location.

20. The computer program product of claim 15, further including program instructions to:
monitor, by the one or more processors, the first geographical characteristics, the second geographical characteristics, and the predefined constraints, and
re-identify, by the one or more processors, the secondary site based on one or more changes detected during the monitoring.
